(19) United States
(12) Patent Application Publication
(10) Pub. No.: US 2023/0311406 A1
(43) Pub. Date: Oct. 5, 2023

(54) ADDITIVELY MANUFACTURED OBJECT WITH COLORED INTERNAL CHANNEL

(71) Applicant: Ford Global Technologies, LLC, Dearborn, MI (US)

(72) Inventors: Matthew Cassoli, Southgate, MI (US); Robert D. Bedard, Allen Park, MI (US); Xiaojiang Wang, Saline, MI (US)

(73) Assignee: Ford Global Technologies, LLC, Dearborn, MI (US)

(21) Appl. No.: 17/711,637

(22) Filed: Apr. 1, 2022

(51) Int. Cl. B29C 64/129; B29C 64/264; B29C 64/321; B29C 64/295; B33Y 10/00; B33Y 40/00

(52) U.S. Cl. CPC B29C 64/129; B29C 64/264; B29C 64/321; B29K 2105/0032; B33Y 10/00; B33Y 40/00; B29C 64/295

(57) ABSTRACT

A plurality of layers of material are additively generated to form an internal channel within the part, the internal channel including an inlet and an outlet. A liquid colorant is flowed from the inlet to the outlet. The liquid colorant is diffused into walls of the internal channel. A second plurality of layers of material are additively generated to close the inlet and the outlet such that the internal channel is completely encapsulated within the part.

### FIELD

The present disclosure relates to three-dimensional (3D) printing, or additive manufacturing, and more specifically to parts with internal channels.

### BACKGROUND

The statements in this section merely provide background information related to the present disclosure and may not constitute prior art.

Three-dimensional printing is increasingly being used to manufacture parts for motor vehicles. Various methods for 3D printing are used, including vat photopolymer processes, fused filament fabrication, and selective laser sintering. Generally, some of these 3D printing systems apply material onto a surface, incrementally adding layers of material as each previous layer hardens or cures into a new surface.

In some 3D printed parts, an internal void or channel is generated in the part to form a complex geometry. Such complex geometries can be difficult to modify for both functional and aesthetic purposes. In particular, the internal void or channel may be closed upon completion of printing the part, limiting options for modifying the part after the 3D print/build.

The present disclosure addresses these challenges with 3D printing complex geometries, including by way of example, internal voids or channels.

### SUMMARY

This section provides a general summary of the disclosure and is not a comprehensive disclosure of its full scope or all of its features.

In one form, a method for producing an additively manufactured part comprises additively generating a plurality of layers of material to form an internal channel within the part, the internal channel including an inlet and an outlet, flowing a liquid colorant from the inlet to the outlet, diffusing the liquid colorant into walls of the internal channel, and additively generating a second plurality of layers of material to close the inlet and the outlet such that the internal channel is completely encapsulated within the part.

In variations of the method, which may be implemented individually or in any combination: at least a portion of the additively manufactured part around the internal channel is free of colorant; the material is a transparent polymer; the liquid colorant is one of a dye dissolved into a solvent or a pigment dispersed in the solvent; the plurality of layers of material are additively applied in a vat photopolymer process; the vat photopolymer process comprises actuating a light source disposed beneath a transparent reservoir of liquid transparent polymer and curing the liquid transparent polymer into the plurality of layers with light emitted from the light source; the second plurality of layers is transparent; the solvent is removed before additively applying the second plurality of layers; the first plurality of layers is heated to remove the solvent by evaporation; a pump is actuated to remove the solvent; a final layer of the second plurality of layers is transparent and free of colorant; the part is removed from an additive printing machine and, then, the liquid colorant is flowed from the inlet to the outlet; the solvent is removed upon diffusing the colorant into the internal channel, the first plurality of layers is placed into the additive printing machine, and the second plurality of layers is applied with the additive printing machine; the internal channel formed by a vat photopolymer process is curved.

In another form, a method for providing color to an interior portion of an additively manufactured part comprises flowing a liquid colorant through an internal channel of the additively manufactured part, the additively manufactured part soluble by the liquid colorant, diffusing the colorant into walls of the internal channel, and removing the colorant from the internal channel, wherein upon removal of the colorant, the internal channel is colored according to the colorant, and at least a portion of the additively manufactured part around the internal channel is transparent.

In variations of the method, which may be implemented individually or in combination: the method further includes heating the additively manufactured part to remove the colorant by evaporation; actuating a pump to remove the colorant; upon removal of the colorant, additively applying a layer of material to close the internal channel; the internal channel is curved; the additively manufactured part is formed in a vat photopolymer process of transparent polymer.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of an additive manufacturing system according to the present disclosure;

FIGS. 2A-2B are views of a part manufactured with the additive manufacturing system with a colored internal channel according to the present disclosure;

FIG. 3 is an enlarged view of the part with the colored internal channel along the line 3-3.

FIGS. 4A-4C are views of another part manufactured with the additive manufacturing system with a colored internal channel according to the present disclosure; and

FIG. 5 is a manufacturing flow diagram of a process for additively manufacturing a part with a colored internal channel according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

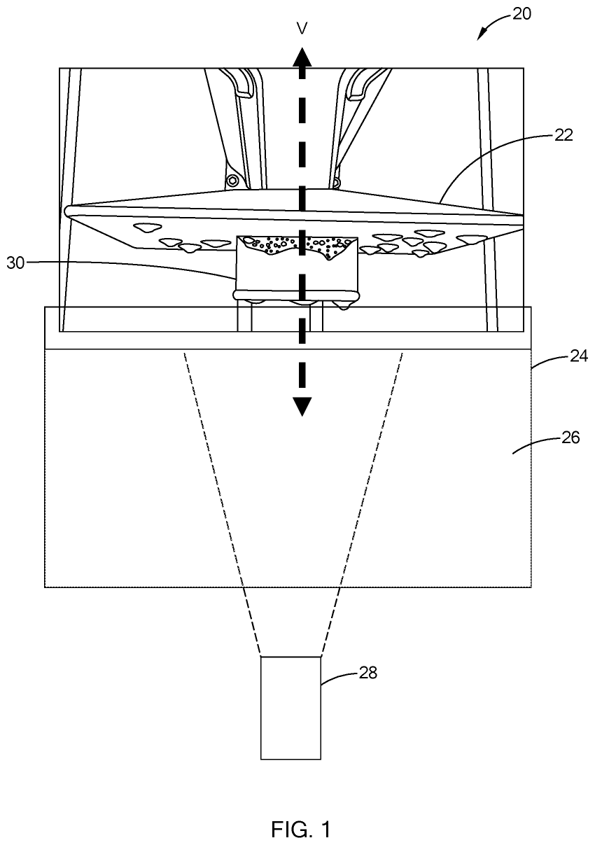

With reference to FIG. 1, an additive manufacturing system 20 includes a movable platform 22, a reservoir 24 of liquid polymer 26, and a light source 28. The additive manufacturing system 20 is a system for an additive manufacturing, or 3D printing process. In this context, “3D printing” is a process by which material is progressively deposited onto previous material in order to form a part 30.

In one form, the additive manufacturing system 20 is a vat photopolymer (VPP) system 20. The VPP system 20 forms a part 30 by inserting the platform 22 into the reservoir 24 (referred to as a “vat” in VPP contexts) below the platform 22 and curing liquid polymer 26 in the reservoir 24 with light emitted from the light source 28 in a plurality of layers onto a surface of the platform 22. The platform 22 is then removed from the vat 24, and the solid part 30 is removed from the platform 22. VPP provides a way to print three-dimensional (3D) parts 30 that include internal cavities and/or channels because the light emitted from the light source 28 cures polymer 26 on a partial surface the light reaches, additively curing polymer 26 around a cavity to be used as a fluid channel.

The platform 22 of the VPP system 20 is movable along a vertical direction V into and out of the reservoir 24. The VPP system 20 includes one or more movable components, such as a linear actuator or a robotic arm, that move the platform into the reservoir, submerging at least a portion of the platform in the liquid polymer. The light reaches the surface of the platform 22 and cures the liquid polymer 26 adjacent to the platform, forming a solid layer of polymer 26. Then, the light reaches the solid layer and cures the liquid polymer 26 adjacent to the solid layer, forming a second solid layer of polymer 26 onto the first solid layer of polymer 26.

The light source 28 emits light to cure the polymer 26 onto the platform 22, applying a layer of transparent polymer 26 to the platform 22. The light source 28 can emit light at a specified wavelength, such as visible light or ultraviolet light, and/or a laser. The light source 28 in one form is a laser device, and in another form is a light-emitting diode. Other devices that emit light are within the scope of the present disclosure. The light source 28 is disposed beneath the transparent reservoir 24, and the light from the light source 28 travels through the walls of the reservoir 24 and the liquid polymer 26 until reaching the surface of the platform 22 or a layer of cured polymer 26. In this context, the “transparent” reservoir 24 and “transparent” polymer 26 allow at least some light to pass through the reservoir 24 and the polymer 26, such that translucent and semi-transparent reservoirs 24 and polymers 26 are within the scope of the present disclosure. The light source 28 includes one or more devices (not shown) to control emitted light based on the shape of the layer to be formed onto the platform 22 to form the part 30, for example, a movable screen that blocks at least a portion of light emitted from the light source 28.

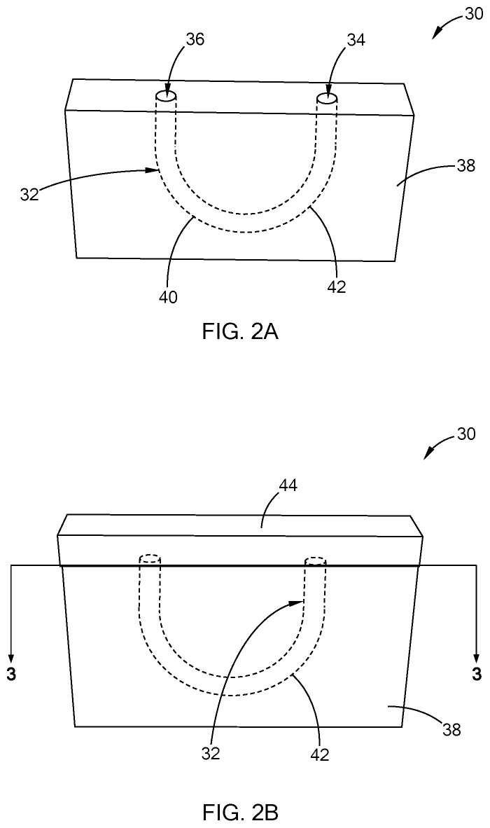

With reference to FIGS. 2A-2B, a part 30 formed with the VPP system 20 includes an internal channel 32. The internal channel 32 is a cavity extending from an inlet 34 to an outlet 36. The internal channel 32 is designed to allow fluid to flow from the inlet 34 to the outlet 36. The internal channel 32 is formed by additively generating layers 38 of polymer 26 with portions of the light source 28 blocked to prevent polymer 26 from curing at specified portions of the surface. The uncured portions are surrounded by cured polymer 26, and when the uncured polymer 26 is removed, the remaining void is the internal channel 32. The channel 32 in the form of FIG. 2 has a curved U-shape, and the channel 32 can have any suitable shape when additively generated from the layers 38 of polymer 26, and thus the curved U-shape should not be construed as limiting the scope of the present disclosure.

To remove excess polymer 26 from the internal channel, the part 30 is removed from the VPP system 20 and a solvent 40 is flowed or injected through the internal channel 32 to clean the excess polymer 26. The solvent 40 is a liquid that dissolves the polymer 26 used in the VPP printing system 20, such as an alcohol (e.g., isopropyl alcohol (IPA) or isopropanol), ethers, esters (e.g., dimethyl adipate), and ketones (e.g., acetone), by way of example. Flowing the solvent 40 from the inlet 34 to the outlet 36 removes excess liquid polymer 26 that would otherwise adhere to the wall of the internal channel 32 and generally provides smoother walls of the internal channel 32. The solvent 40 moves and/or dissolves the liquid polymer 26 to evacuate the internal channel 32, and the solvent 40 dissolves some of the wall of the internal channel 32, resulting in a wall with a smoother surface.

The solvent 40 includes a colorant 42, such as a dye or a pigment, that diffuses into the internal channel 32 to color the walls of the internal channel 32. The solvent 40 and the colorant 42 mixture is a “liquid colorant.” The liquid colorant flowing from the inlet 34 to the outlet 36 removes excess polymer 26, as described above, and provides color to the material surrounding the internal channel 32. Thus, the liquid colorant provides a dual-function according to the teachings of the present disclosure.

In one form, the colorant 42 is a liquid dye dissolved in the solvent 40, and in another form is a solid pigment dispersed in the solvent 40. The liquid dye or solid pigment diffuses into the wall of the internal channel 32 and is visible through the transparent portions of the part 30 proximate to the internal channel 32. That is, the colorant 42 diffuses through walls of the internal channel 32, but not through the entire part 30, and at least a portion of the part 30 around the internal channel 32 is free of colorant 42.

Upon diffusing the colorant 42 into the internal channel 32, the solvent 40 is removed from the part 30. In one form, the part 30 is heated to remove the solvent 40 by evaporation. In another form, a pump is actuated to remove the solvent 40 from the internal channel 32. In another form, the part 30 is placed such that the inlet 34 and the outlet 36 align with the direction of gravity, and the solvent 40 flows out from the inlet 34 and the outlet 36 by gravity. Upon removal of the solvent 40, the diffused colorant 42 remains, and the internal channel 32 is colored according to the colorant 42. The part 30 is then returned to the VPP system 20 to complete manufacturing.

After removal of the excess polymer 26 and the solvent 40, a second plurality of layers 44 of material are additively generated to close the inlet 34 and the outlet 36 such that the internal channel 32 is completely encapsulated within the part 30. As with the first plurality of layers 38, the part 30 is lowered into the reservoir 24 and the light source 28 cures layers 44 of polymer 26 onto the part 30. Because the second plurality of layers 44 are free of colorant 42, the second plurality of layers 44 are transparent, and the colored internal channel 32 is visible through the second plurality of layers 44. In particular, a final layer of the second plurality of layers 44 is transparent and free of liquid colorant 42 such that the internal channel 32 is visible through the final layer. Upon curing of the final layer, the part 30 is removed from the VPP system 20, resulting in a part 30 that has a colored internal channel 32 surrounded by transparent polymer 26 through which the colored internal channel 32 is visible. In the form of FIG. 2, the U-shaped colored internal channel 32 is visible through the transparent layers 38, 44 of polymer 26 as shown.

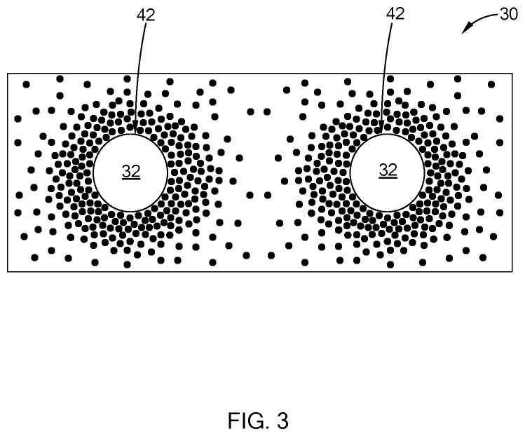

With reference to FIG. 3, the walls of the internal channel 32 of the part 30 are diffused with the colorant 42. Upon evacuation of the excess polymer 26 and solvent 40, the internal channel 32 is empty, and the colorant 42 remains. As described above, the colorant 42 diffuses into some, but not all, of the polymer 26 surrounding the internal channel 32, and portions of the part 30 away from the internal channel 32 are free of colorant 42. Thus, in the top-down cross-sectional view of FIG. 3, the colorant 42 radially diffuses from the walls of the empty internal channel 32, coloring the walls of the internal channel 32.

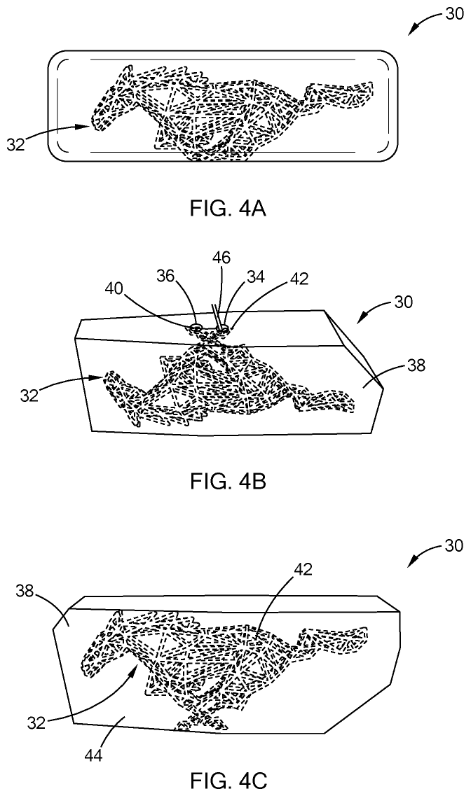

With reference to FIGS. 4A-4C, the internal channel 32 of the part 30 has a form of a more complex shape than the U-shape of FIGS. 2A-3. As shown in FIG. 4A, the internal channel 32 is modeled (i.e., in a CAD system) in a file format compatible as input to the VPP system 20 such that the first plurality of layers 38 forms the internal channel 32 upon curing by the light source 28. In one form, the part 30 is modeled in a conventional manner such that the VPP system 20 adjusts the device that blocks the light source 28 in specific locations to cure layers 38 that form the internal channel 32.

Upon forming the first plurality of layers 38 with the internal channel 32, the part 30 is removed from the VPP system 20 and the colorant 42 is flowed from the inlet 34 to the outlet 36. FIG. 4B shows a fluid injector 46 that flows the solvent 40 and the colorant 42 through the internal channel 32. As described above, the colorant 42 can be a dye dissolved in the solvent 40 or a solid pigment dispersed in the solvent 40. The colorant 42 diffused into walls of the internal channel 32 such that the complex shape is visible through the transparent portions of the part 30. In one form, to diffuse the colorant 42, the part 30 is moved in a machine that applies a centrifugal force or a vibration to move the colorant 42 through the internal channel 32. In another form, to diffuse the colorant 42, the part 30 is pressurized to force the colorant 42 into the walls of the internal channel 32. As shown in FIG. 4C, once the colorant 42 diffuses into the internal channel 32, the remaining solvent 40 with the colorant 42 is removed and the second plurality of layers 44 is formed to encapsulate the internal channel 32. The dyed internal channel 32 is thus visible through the transparent surfaces of the part 30. The parts 30 of FIGS. 2A-4B include a single internal channel 32, and it is within the scope of the present disclosure to include a plurality of internal channels 32 and to provide a respective color to walls of each internal channel 32 of the part 30.

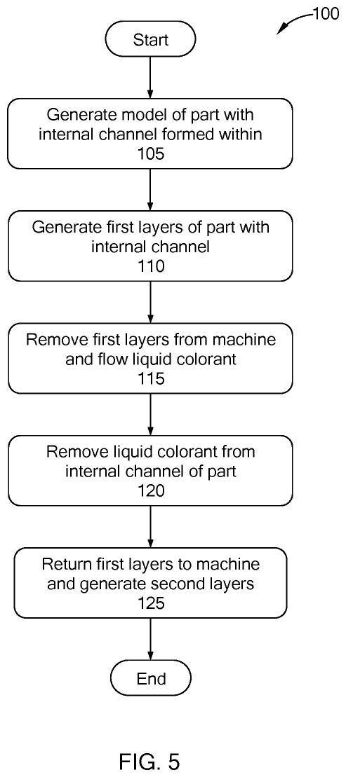

FIG. 5 is a block diagram of an example manufacturing process 100 for 3D printing a part 30 with an internal channel 32 having colored walls. The process 100 begins in a block 105, in which a model of a part 30 is generated, the model including an internal channel 32 formed within. The model is generated to be compatible with an additive manufacturing system 20, such as a VPP system 20 shown in FIG. 1.

Next, in a block 110, a first plurality of layers 38 are additively generated in the additive manufacturing system 20 to form the internal channel 32 with an inlet 34 and an outlet 36. In one form, a light source 28 of the VPP system 20 is actuated to cure layers 38 of polymer 26 onto a platform 22 lowered into a reservoir 24 of the polymer 26. A device to block a portion of the light from the light source 28 is actuated to form cavities that, when joined in the first plurality of layers 38, form the internal channel 32. The light source 28 and device are actuated according to the generated model.

Next, in a block 115, the additive manufacturing process is paused and the first plurality of layers 38 of the part 30 are removed from the platform 22 to flow a solvent 40 and a liquid colorant from the inlet 34 of the internal channel 32 to the outlet 36. The liquid colorant is a liquid dye dissolved in a solvent 40 or a solid pigment dispersed in the solvent 40. The solvent 40 removes excess material from the first plurality of layers 38, and the colorant 42 diffuses into the internal channel 32, providing color to the internal channel 32. In one form, the solvent 40 dissolves the polymer 26 used in the VPP system 20.

Next, in a block 120, excess liquid colorant is removed from the internal channel 32 of the part 30. As described above, in one form, a heater is actuated to evaporate the solvent 40. In another form, a pump is actuated to remove the solvent 40. In another form, the part 30 is disposed such that the solvent 40 leaves the internal channel 32 by gravity. When the liquid colorant is removed, the internal channel 32 is colored according to the diffused colorant 42 that remains.

Next, in a block 125, the part 30 is returned to the platform 22 of the additive manufacturing system 20, the part 30 is lowered into the reservoir 24 of polymer 26, and a second plurality of layers 44 is generated to encapsulate the internal channel 32. As described above, the second plurality of layers 44 close the inlet 34 and the outlet 36, providing layers of transparent material through which the colored internal channel 32 is visible. Encapsulating the internal channel 32 prevents additional colorant 42 from entering or exiting the part 30. Following the block 125, the process 100 ends.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for producing an additively manufactured part, the method comprising:
additively generating a plurality of layers of material to form an internal channel within the part, the internal channel including an inlet and an outlet;
flowing a liquid colorant from the inlet to the outlet;
diffusing the liquid colorant into walls of the internal channel; and
additively generating a second plurality of layers of material to close the inlet and the outlet such that the internal channel is completely encapsulated within the part.

2. The method according to claim 1, wherein at least a portion of the additively manufactured part around the internal channel is free of colorant.

3. The method according to claim 1, wherein the material is a transparent polymer.

4. The method according to claim 1, wherein the liquid colorant is one of a dye dissolved into a solvent or a pigment dispersed in the solvent.

5. The method according to claim 1, further comprising additively applying the plurality of layers of material in a vat photopolymer process.

6. The method according to claim 5, wherein the vat photopolymer process comprises actuating a light source disposed beneath a transparent reservoir of liquid transparent polymer and curing the liquid transparent polymer into the plurality of layers with light emitted from the light source.

7. The method according to claim 1, wherein the second plurality of layers is transparent.

8. The method according to claim 1, further comprising removing the remaining liquid colorant before additively applying the second plurality of layers.

9. The method according to claim 8, further comprising heating the plurality of layers to remove the remaining liquid colorant by evaporation.

10. The method according to claim 8, further comprising actuating a pump to remove the remaining liquid colorant.

11. The method according to claim 1, wherein a final layer of the second plurality of layers is transparent and free of colorant.

12. The method according to claim 1, further comprising removing the part from an additive printing machine and, then, flowing the liquid colorant from the inlet to the outlet.

13. The method according to claim 12, further comprising removing the remaining liquid colorant upon diffusing the liquid colorant into the walls of the internal channel, placing the plurality of layers into the additive printing machine, and applying the second plurality of layers with the additive printing machine.

14. The method according to claim 1, wherein the internal channel formed by a vat photopolymer process is curved.

15. A method for providing color to an interior portion of an additively manufactured part, the method comprising:
flowing a liquid colorant through an internal channel of the additively manufactured part, the additively manufactured part soluble by the liquid colorant;
diffusing the colorant into walls of the internal channel; and
removing the colorant from the internal channel;
wherein upon removal of the colorant, the internal channel is colored according to the colorant, and at least a portion of the additively manufactured part around the internal channel is transparent.

16. The method according to claim 15, further comprising heating the additively manufactured part to remove the colorant by evaporation.

17. The method according to claim 15, further comprising actuating a pump to remove the colorant.

18. The method according to claim 15, wherein the internal channel is curved.

19. The method according to claim 15, wherein the additively manufactured part is formed in a vat photopolymer process of transparent polymer.

20. The method according to claim 15, further comprising, upon removal of the colorant, additively applying a layer of material to close the internal channel.
